(19) United States
(12) Patent Application Publication
(10) Pub. No.: US 2024/0173874 A1
(43) Pub. Date: May 30, 2024

(54) LIMB PORTION OF ROBOT

(71) Applicant: ANYBOTICS AG, Zurich (CH)

(72) Inventors: Alessandro Schiavone Scafato, Schwerzenbach (CH); David Sekanina, Zurich (CH); Severin Aregger, Zurich (CH); Taihei Ueno, Zurich (CH); Ursin Hutter, Zurich (CH)

(21) Appl. No.: 18/284,114

(22) PCT Filed: Mar. 31, 2021
(86) PCT No.: PCT/EP2021/058517

§ 371 Date: Sep. 26, 2023

(51) Int. Cl. B25J 18/00

(52) U.S. Cl. CPC B25J 18/00

(57) ABSTRACT

Limb portion 1000, in particular a thigh, for a limb of a robot comprising a first actuator 1 adapted to pivotably couple with a first further limb section and a second actuator 2 adapted to pivotably couple with a second further limb section. In addition, the limb portion 1000 comprises a housing 4 enclosing a first heat source 10 of the first actuator 1 and a second heat source 20 of the second actuator 2. The housing 4 forms a cavity 40 that thermally couples to the first heat source 10 and to the second heat source 20. The housing comprises a first air opening 41 and an second air opening 42 for an airstream to vent the cavity 4.

### TECHNICAL FIELD

The present invention relates to a limb portion, a limb comprising the limb portion, a legged robot comprising the limb, and a first and a second method for cooling the limb portion.

### BACKGROUND

Robots are designed for a specific application but can further conduct specific missions or take over a specific task. In particular robots can comprise one or more limb such as one or more arms and/or one or more legs to be able to conduct such a specific task or mission.

The limbs are often designed to mimic the movement of a human or animal limb. To design a robot limb in a way to have multiple degrees of movement, it consists of multiple limb portions that are connected with each other to form a well manoeuvrable and movable limb that is able to conduct even complex movement patterns.

Document Zhong et al., “Analysis and Re-search of Quadruped Robot Leg's: A comprehensive Re-view”, Int. J. of Adv. Robotic Systems, vol. 16, pages 1-15, discloses a quadruped robot, wherein each limb of the robot comprises multiple limb portions.

Tasks assigned to such a robot might re-quire that the robot enters rough terrain where it is exposed to heat, water and dirt, or an explosive environment.

The often complex design of the limbs comprising electronic connections, chips and logic circuits might be very sensitive to such an environment. In particular if logic circuits or cables are exposed to violent shocks or extreme heat, this can lead to damages of the limb or in the worst case to the failure of the whole robot.

### BRIEF SUMMARY

The problem to be solved by the present invention is therefore to provide a design for a limb portion that protects the limb portion against damages during a mission.

The problem is solved by the subjects of the independent claims concerning a first, a second, a third a fourth, and a fifth aspect of the invention.

Unless otherwise stated, the following definitions shall apply in this specification:

The terms “a”, “an”, “the” and similar terms used in the context of the present invention are to be construed to cover both the singular and plural unless otherwise indicated herein or clearly contradicted by the context. Further, the terms “including”, “containing” and “comprising” are used herein in their open, non-limiting sense. The term “containing” shall include both, “comprising” and “consisting of”.

Advantageously, the term “arranged in a line” refers to an arrangement, wherein a line can be drawn through all parts in a three dimensional room.

Advantageously, the term “torso of a robot” or “torso” refers to a main body of a robot comprising the logic components for controlling the robot and wherein the limb section or limb is attached to the torso. In particular, wherein the torso might comprise multiple limbs, e.g. for a quadruped robot.

These definitions are not limiting the scope of protection.

A first aspect of the invention concerns a limb portion for a robot comprising a first actuator, a second actuator and a housing. The housing encloses, in particular only partially encloses, a first heat source of the first actuator and a second heat source of the second actuator.

Furthermore, the housing forms a cavity.

In addition, the housing comprises a first air opening, in particular an air inlet, and a second air opening, in particular an air outlet, for an air-stream to vent the cavity.

The first actuator is adapted to pivot the limb portion around a first pivot axis and to pivotably couple it to a first further section of the robot limb.

The second actuator is adapted to pivot the limb portion around a second pivot axis and to pivot-ably couple it to a second further section of the robot limb.

In an advantageous embodiment of the invention, the cavity thermally couples to the first heat source of the first actuator and to the second heat source of the second actuator.

In a further advantageous embodiment of the invention, the housing forms further a second cavity, wherein the housing comprises a third air opening and a fourth air opening for an airstream to vent the second cavity. In particular in this embodiment, the cavity thermally couples to the second heat source and the second cavity thermally couples to the first heat source. In particular, in such an embodiment, the cavity and the second cavity are separated by a separating wall. In particular, the separating wall is arranged essentially in the middle of the limb portion.

Advantageously, the actuators are adapted to mechanically and/or electrically couple to another section of the limb, another limb portion, or to the robot torso.

The limb portion is advantageously a thigh of the robot limb, coupled with the first actuator to a shank and with the second actuator to a hip abduction adduction.

In particular, the cavity refers to space within the limb portion that is enclosed by a housing. The housing might be fully enclosing the cavity or might have openings. In particular, the housing might comprise multiple housing parts that form a cavity, wherein the cavity does not need to be fully enclosed by the multiple housing parts.

In an advantageous embodiment of the invention, the first heat source of the first actuator is a first electric drive and/or the second heat source of the second actuator is a second electric drive that generates heat. Since the heat sources are in thermal connection with the cavity, the air within the cavity heats up.

Therefore, the first air opening and the second air opening allow to vent the cavity with air that means that the air within the cavity is exchanged for cooling down the air temperature within the cavity and therefore cooling the first and second heat source.

Advantageously, the first air opening is arranged close to the first actuator and the second air opening is arranged close to the second actuator.

In a further advantageous embodiment, the first air opening, the first heat source, the second heat source and the second air opening are aligned in a line.

In a further advantageous embodiment of the invention, the first pivot axis is arranged parallel to the second pivot axis.

In a further advantageous embodiment of the invention, a first rotation direction of the first pivot axis and a second rotation direction of the second pivot axis are directing in opposite directions.

In a further advantageous embodiment of the invention, the first heat source and/or the second heat source is at least one cooling rib thermally connected to a stator, a circuitry, and/or a gear box of the respective first and/or second electric drive.

In an advantageous embodiment of heat source, the first and/or second electric drive comprises cooling ribs to transport the heat away from the hot parts of the respective electric drive. The cooling ribs are the heat sink of the electric drive respectively the actuator.

In an advantageous embodiment of the invention, first cooling ribs of the first actuator and/or second cooling ribs of the second actuator are arranged within the airstream between the first air opening and the second air opening.

In particular, the cooling ribs are orient-ed in a direction of the airflow. Therefore, advantageously, the first air opening, the first cooling ribs and/or the second cooling ribs and the second air opening are arranged in a line.

In a further advantageous embodiment of the invention, at least one fan is arranged within the cavity to actively vent the cavity.

In particular, the at least one fan might be a pull fan for pulling the air from the first air opening into the cavity. The at least one fan is advantageously arranged between the first actuator and the second actuator, advantageously closer to the first actuator and/or closer to the first air opening.

In a further embodiment, the at least one fan might be a push fan for pushing the air out of the cavity towards the second air opening, in particular towards an air outlet. The at least one fan is advantageously arranged between the first actuator and the second actuator, advantageously closer to the second actuator and/or closer to the second air opening.

In a further advantageous embodiment of the invention, a second fan is arranged within the cavity. Advantageously, in such an embodiment, the at least one fan is a pull fan for pulling the air into the cavity and the second fan is a push fan for pushing the air out of the cavity.

In a further advantageous embodiment of the invention, a second fan is arranged within the second cavity, to actively vent the second cavity.

In a further advantageous embodiment of the invention, the cavity might comprise a temperature sensor for measuring a temperature Tmax, for controlling the overheating within the cavity. In particular, the fan is only activated, if the temperature within the cavity exceeds a certain threshold temperature Tmax, with Tmax≥40°, in particular with Tmax≥50°.

In a further advantageous embodiment of the invention, the limb portion comprises further a third actuator coupled to the second actuator.

In particular, the second and/or third actuator is mechanically and/or electrically coupleable to a torso of the robot.

In particular, the first, second, and/or third actuator are torque density proprioceptive actuators. Each actuator integrates a drive and a gear. Each actuator has appropriate torque output and high efficiency and enables force control in all applications.

In a further advantageous embodiment of the invention, the first actuator is pivotably coupled to a shank.

In particular, such a coupling might be done by means of the knee flexion extension joint mechanism. In particular, the knee joint between the first actuator and the shank is driven by the actuator and knee flexion extension joint mechanism.

In particular, a coupling mechanism is de-signed to move the first further limb section, in particular a shank, with an angle from 0 to 360°.

In particular, the knee flexion extension joint mechanism supports a knee-like movement of the shank in relationship to the first actuator.

In a further advantageous embodiment of the invention, the second actuator together with a second linkage mechanism is a hip flexion extension, in particular of a legged robot or a quadruped robot.

In a further advantageous embodiment of the invention, the second actuator is pivotably coupled to the third actuator, in particular by means of a hip flexion extension mechanism. In particular, the abduction/adduction joint of the hip joint is driven by the actuator and the hip flexion extension mechanism.

Advantageously, the hip flexion extension mechanism allows a hip-like movement, meaning a movement with multiple degrees of freedom, of the second actuator versus the third actuator or the robot torso respectively.

In a further advantageous embodiment of the invention, at least one cable that connects the first actuator to the second actuator or to the torso of the robot passes through the cavity. In particular, all cables that are connected to the first actuator pass through the cavity.

In a further advantageous embodiment of the invention, the first actuator comprises a first tubular opening extending along the first pivot axis. The tubular opening of the first actuator is in particular adapted to serve as a first cable duct.

The second actuator comprises a second tubular opening extending along the second pivot axis. The tubular opening of the second actuator is in particular adapted to serve as a second cable duct.

In particular, the first cable duct is adapted to feed through at least one cable of the first further section that connects the first further section to the torso of the robot via the first tubular opening, the cavity, and the second tubular opening.

In particular, the second tubular opening is adapted to feed through at least one cable that connects the first actuator and/or a first further section to the robot torso or to the third actuator.

In an advantageous embodiment of the invention, the at least one cable that connects the first actuator and/or the first further section to the robot torso passes the cavity and the second cable duct.

Advantageously, one or more power cables connect the limb portion and/or the limb directly or indirectly to a power source of the torso.

Further advantageously, one or more logic cables connect the limb portion and/or the limb directly or indirectly to a logic processing unit of the tor-so.

In a further advantageous embodiment of the invention, at least one first cable, in particular a power cable, for connecting the first actuator to the torso of the robot, passes through the cavity and through the second cable duct.

In a further advantageous embodiment of the invention, at least one second cable, in particular a power cable, for connecting the second actuator to the torso of the robot, passes through the second cable duct.

In a further advantageous embodiment of the invention, an at least one third cable, in particular a logic cable, for connecting the first actuator to the second actuator, passes through the cavity.

In a further advantageous embodiment of the invention, an at least one fourth cable, in particular a logic cable, for connecting the second actuator to the third actuator or to the torso of the robot, passes through the second cable duct.

A second aspect of the invention refers to a limb of a robot. The limb comprises a limb portion according to a first aspect of the invention, a first further limb section and a second further limb section.

Advantageously, the limb portion is a thigh.

Advantageously, the first further limb section is a shank, pivotably coupled with a proximal end to the thigh by means of the first actuator or the knee flexion extension respectively.

Advantageously, the second further limb section is a third actuator, in particular a hip abduction adduction, coupled to the thigh by means of the second actuator or the hip flexion extension respectively.

The abduction/adduction joint of the hip joint is driven by the actuator and a linkage mechanism, which enables the robot to realize the swinging and twisting motion.

In a further advantageous embodiment of the invention according to the second aspect, the limb comprises a hoof that is arranged at a distal end of the shank, opposite to the proximal end of the shank.

A third aspect of the invention refers to a legged robot comprising a limb according to the second aspect, in particular comprising four limbs according to the second aspect.

A fourth aspect of the invention refers to a method for cooling the limb portion according to the first aspect of the invention. The method comprises the step of activating the at least one fan only if a temperature sensor arranged within the cavity measures a temperature Tmax≥40° C., in particular Tmax≥50° C.

In a further advantageous embodiment, if the fan and the second fan are arranged within one cavity, the method comprises the step of activating the second fan only if Tmax≥100° C.

In particular, if the at least one fan is arranged within a first cavity and the second fan is arranged within the second cavity, the method comprises the steps of activating the at least one fan and/or second fan independently from each other if a temperature sensor in the cavity or second cavity measures a temperature Tmax≥40° C., in particular Tmax≥50° C.

A fifth aspect of the invention refers to a method for cooling the limb section according to the first aspect of the invention, wherein the at least one fan is arranged close to the first actuator and the second fan is arranged close to the second actuator. The method comprises the steps of activating the at least one fan 410 if a first temperature sensor close to the first actuator measures a temperature Tmax≥40° C., and/or activating the second fan 420 if a second temperature sensor close to the second actuator measures a temperature Tmax≥40° C., in particular Tmax≥50°.

Other advantageous embodiments are listed in the dependent claims as well as in the description below.

### BRIEF DESCRIPTION OF THE DRAWINGS

The invention will be better understood and objects other than those set forth above will become apparent from the following detailed description there-of. Such description makes reference to the annexed drawings, wherein:

FIG. 1a shows a schematic cross section of a limb portion according to an embodiment of the first aspect of the invention;

FIG. 1b shows a schematic cross section of a further limb portion according to a further embodiment of the first aspect of the invention;

FIG. 2 shows a schematic cross section of a limb portion according to a further embodiment of the first aspect of the invention;

FIG. 3a shows a schematic view of a limb portion according to a further embodiment of the inventions wherein a housing that covers the cavity is re-moved,

FIG. 3b shows a schematic view of a limb portion according to a further embodiment of the invention wherein the housing for covering the cavity is in place;

FIG. 4a shows a schematic view of a limb portion according to a further embodiment of the inventions wherein a housing that covers the cavity is re-moved,

FIG. 4b shows a schematic view of a limb portion according to a further embodiment of the invention wherein the housing for covering the cavity is in place;

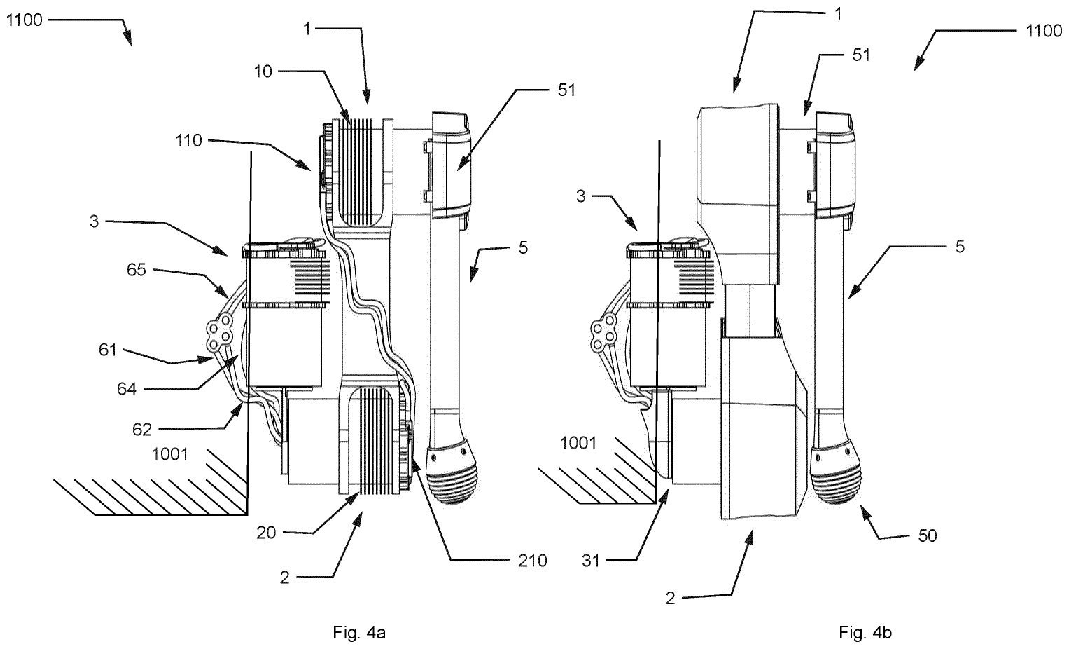

In addition, FIGS. 4a and 4b show an embodiment according to the second aspect of the invention.

### DETAILED DESCRIPTION

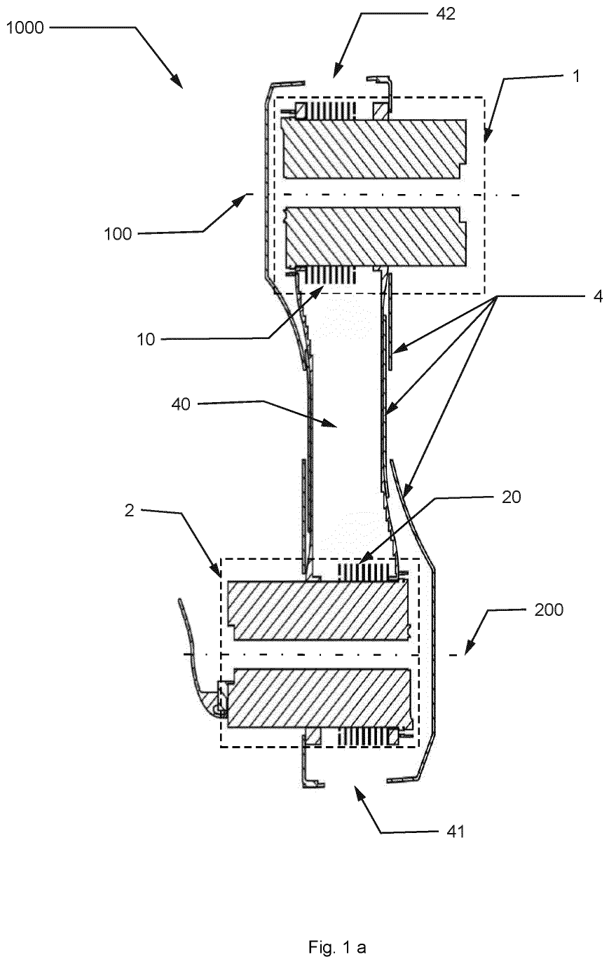

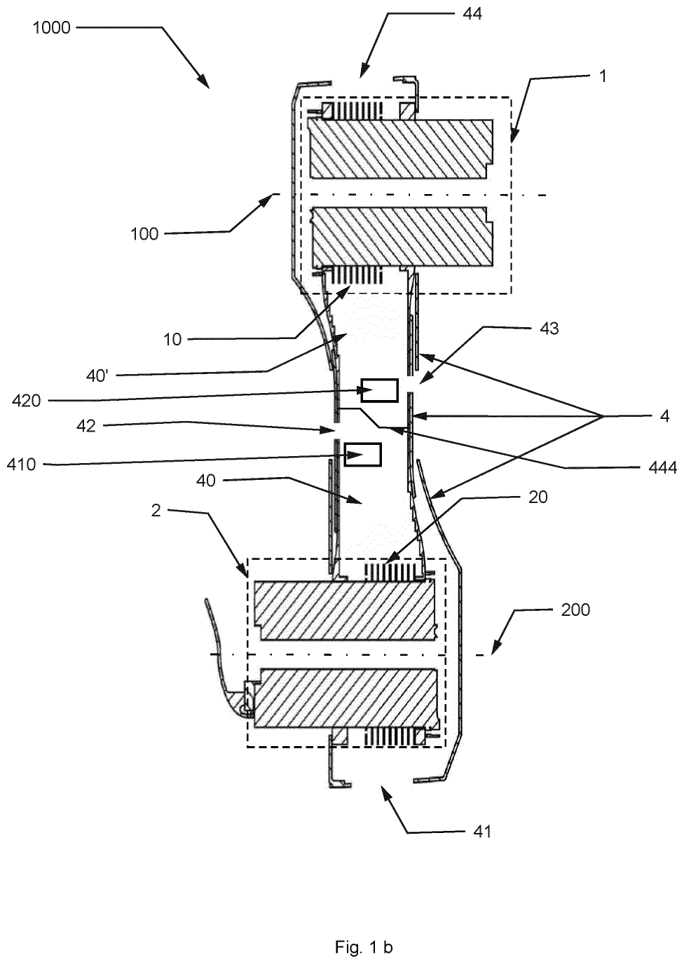

FIG. 1a shows a schematic cross section of a limb portion 1000 according to an embodiment of the invention. The limb portion 1000 comprises a first actuator 1, a second actuator 2, and a housing 4.

The first actuator 1 is adapted to pivot-ably couple with a first further limb section. The second actuator 2 is adapted to pivotably couple to a second further limb section.

The housing 4 encloses a first heat source 10 of the first actuator 1 and a second heat source 20 of the second actuator 2.

In the embodiment as shown in FIG. 1a, the housing 4 comprises three parts that form the cavity 40.

The housing 4 forms a cavity 40 that thermally couples to the first heat source 10 of the first actuator 1 and to the second heat source 20 of the second actuator 2.

The housing 4 comprises further an first air opening 41, in particular an air inlet, and a second air opening 42, in particular an air outlet, for an airstream to vent the cavity 40.

Advantageously, a first pivot axis 100 of the first actuator 1 is arranged parallel to a second pivot axis 200 of the second actuator.

Further advantageously, a first rotation direction of the first pivot axis 100 and a second rotation direction of the second pivot axis 200 are directing in opposite directions.

In an advantageous embodiment of the embodiment, the first actuator 1 is a first electric drive and/or the second actuator 2 is a second electric drive.

In a further advantageous embodiment of the invention, the first heat source 10 and/or the second heat source 20 is one or more cooling rib thermally connected to a stator, a circuitry, and/or a gearbox of the respective first/and or second electric drive. In particular, the first 10 and/or second 20 heat source are cooling ribs arranged on the surface of a first 1 and/or second 2 actuator respectively electronic drive.

FIG. 1b shows a schematic of a cross section according to a further embodiment of the limb portion 1000. The housing 4 forms further a second cavity 40′, wherein the housing comprises a third air opening 43 and a fourth air opening 44 for an airstream to vent the second cavity 40′. In particular the cavity 40 thermally couples to the second heat source 20 and the second cavity thermally couples to the first heat source 10.

As shown in FIG. 1b, the second air opening 42 for this embodiment is arranged in center region of the limb portion. A separating wall 444 separates the first cavity 40 from the second cavity 40′.

In an advantageous embodiment, the limb portion comprises a fan 410 arranged within the first cavity 40 to actively vent the first cavity 40, and/or comprises a second fan 420 arranged within the second cavity 40′ to actively vent the second cavity 40′.

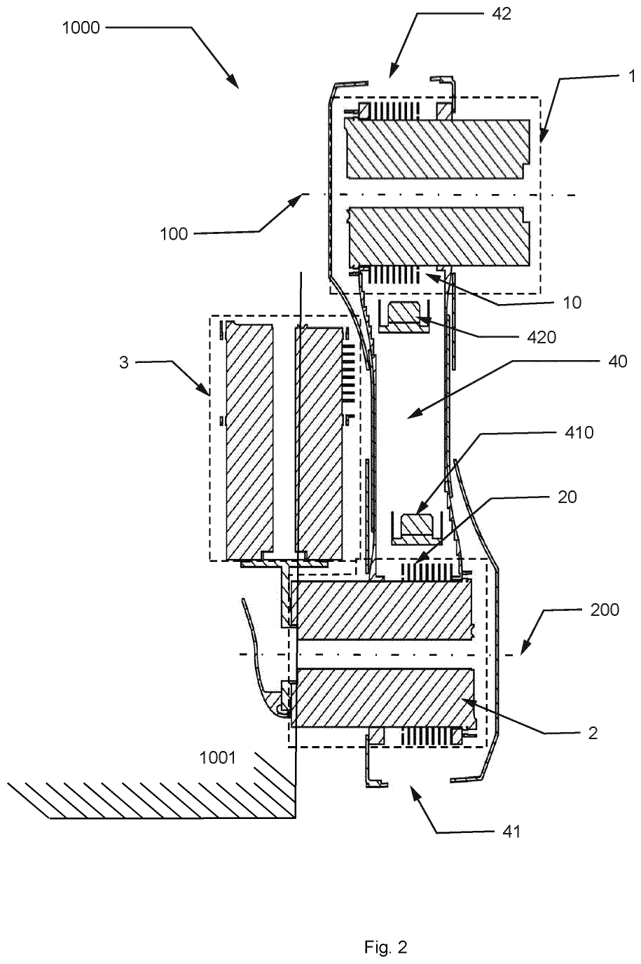

FIG. 2 shows a schematic cross section of a limb portion 1000 according to a further embodiment of the invention.

In addition, to the features as described for FIG. 1a, the limb section 1000 comprises further at least one fan 410 that is arranged within the cavity 4. The at least one fan 410 is advantageously a pull fan for pulling air into the cavity 4 or a push fan for pushing air out of the cavity 4.

Advantageously, the embodiment comprises further a second fan 420. In an advantageous embodiment of the invention, the at least one fan 410 is a pull fan for pulling air into the cavity 4 and the second fan 420 is a push fan for pushing air out of the cavity 4.

Advantageously, the embodiment in FIG. 2 comprises further a third actuator 3. The second actuator 2 pivotably couples to third actuator 3.

In particular, the second 2 and/or third 3 actuator is adapted to mechanically and electrically couple to a torso of the robot 1001.

In particular, the embodiment of the limb section 1000 as shown in the figure can further comprise a temperature sensor arranged within the cavity 40. In particular, the at least one fan 410 arranged within the cavity 40 is only activated if the temperature in the cavity 40 reaches a certain temperature Tmax with Tmax≥40° C., in particular Tmax≥50° C.

Further advantageously, the second fan 420 is only activated if Tmax≥100° C.

In a further advantageous embodiment of the invention, the at least one fan is arranged close to the first actuator and the second fan is arranged close to the second actuator. The at least one fan is activated if a first temperature sensor close to the first actuator 1 measures a temperature Tmax≥40° C., and/or the second fan 420 is activated, if a second temperature sensor close to the second actuator 2 measures a temperature Tmax≥40° C., in particular Tmax≥500.

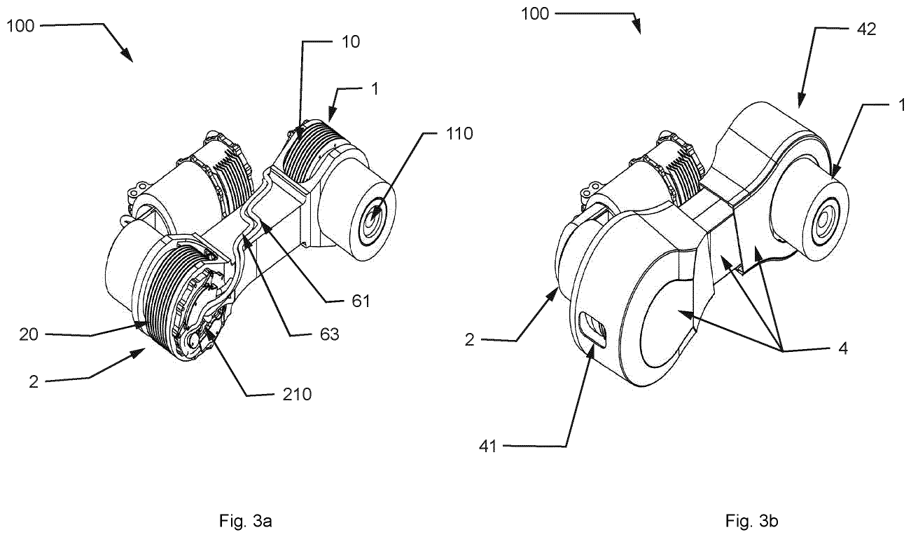

FIG. 3a shows a schematic of a limb portion 1000 according to a further embodiment of the invention, wherein a housing that forms the cavity and comprises the first air opening 41 and the second air opening 42, is removed. The limb portion 1000 comprises the first actuator 1 and the second actuator 2 with the corresponding first 10 and second 20 heat sources.

Cooling ribs that correspond to the first heat source 10 of the first actuator 1 and cooling ribs that correspond to the second heat source 20 of the second actuator 2 are visible.

In a further advantageous embodiment of the invention, the first actuator 1 comprises a tubular opening extending along the first pivot axis 100. In particular, the opening is adapted to serve as a first cable duct 110.

In a further advantageous embodiment of the invention, the second actuator 2 comprises a second tubular opening extending along the second pivot axis 200. In particular, the second opening is adapted to serve as a second cable duct 210.

FIG. 3b shows the embodiment of FIG. 3a with a housing to build the cavity 3.

Under the housing 4, as shown in FIG. 3a at least one cable 61 that connects to the first actuator 1 passes through the cavity 40.

Advantageously, at least one first cable 61, in particular a power cable, for connecting the first actuator 1 to the robot torso 1001 passes through the cavity 40 and through the second cable duct 210.

Further advantageously, at least one second cable 62, in particular a power cable, adapted for connecting the second actuator 2 to the robot torso 1001, is passes through the second cable duct 210.

Further advantageously, at least one third cable 63, in particular a logic cable, for connecting the first actuator 1 to the second actuator 2, passes through the cavity 40.

Further advantageously, at least one fourth cable 64, in particular a logic cable, adapted for connecting the second actuator 2 to the third actuator 3 or to the robot torso 1001, passes through the second cable duct 210.

FIG. 4a shows a schematic of a limb portion 1000 according to a further embodiment of the invention, wherein a housing that forms the cavity and comprises the first air opening 41 and the second air opening 42, is removed. The limb portion 1000 comprises the first actuator 1 and the second actuator 2 with the corresponding first 10 and second 20 heat sources.

Cooling ribs that correspond to the first heat source 10 of the first actuator 1 and cooling ribs that correspond to the second heat source 20 of the second actuator 2 are visible.

Advantageously, the first actuator 1 pivot-ably couples to a shank 5, in particular by means of a knee flexion extension mechanism 51. The knee flexion extension mechanism 51 supports a knee-like movement of the shank 5 in relationship to the first actuator 1.

Further advantageously, the second actuator 2 pivotably couples to the third actuator 3 by means of a hip flexion extension mechanism 31. The hip flexion extension mechanism 31 supports a hip-like movement of the third actuator 3 in relationship to the second ac-tuator 2.

FIG. 4b shows the embodiment of FIG. 4a with a housing 4 to build the cavity 3.

Under the housing 4, as shown in FIG. 4a at least one cable 61 that connects to the first actuator 1 passes through the cavity 40.

Advantageously, at least one first cable 61, in particular a power cable, for connecting the first actuator 1 to the robot torso 1001 passes through the cavity 40 and through the second cable duct 210.

Further advantageously, at least one second cable 62, in particular a power cable, for connecting the second actuator 2 to the robot torso 1001, passes through the second cable duct 210.

Further advantageously, at least one third cable 63, in particular a logic cable, for connecting the first actuator 1 to the second actuator 2, passes through the cavity 40.

Further advantageously, at least one fourth cable 64, in particular a logic cable, for connecting the second actuator 2 to the third actuator 3 or to the robot torso 1001, passes through the second cable duct 210.

Advantageously, the at least one first cable 61 and the at least one second cable 62 are connected to a main body feedthrough 1002 arranged within the robot torso 1002.

In particular, an at least one fifth cable 65, in particular comprising a power connection and a logic connection, from the third actuator 3 connect to the main body feedthrough 1002.

The embodiment as shown in FIG. 4b corresponds further to an embodiment according to the second aspect of the invention, an embodiment of a limb of a robot 1100. The limb 1100 comprises the limb portion 1000 according to a first aspect of the invention, wherein the limb portion 1000 is in particular a thigh. In addition, the limb 1100 comprises a first further limb section, in particular a shank 5, coupled with a proximal end to the limb section. In particular, the shank 5 is coupled to the limb section 1000 by means of a knee flexion extension joint mechanism 51.

The limb 1100 further comprises a second further limb section, in particular a third actuator 3 coupled to the second actuator 2. In particular, the third actuator 3 is coupled to the second actuator 2 by means of a hip flexion extension mechanism 31.

A legged robot comprises at least one limb according to the second aspect of the invention. In particular, a legged robot might comprise a robot torso 1001 and one limb 1100, as shown in FIG. 4a and FIG. 4b.

### REFERENCE LIST

FIRST ACTUATOR 1
FIRST HEAT SOURCE 10
FIRST PIVOT AXIS 100
FIRST CABLE DUCT 110
LIMB PORTION 1000
ROBOT TORSO 1001
LIMB OF A ROBOT 1100
SECOND ACTUATOR 2
SECOND HEAT SOURCE 20
SECOND PIVOT AXIS 200
SECOND CABLE DUCT 210
THIRD ACTUATOR 3
HIP FLEXION EXTENSION MECHANISM 31
HOUSING 4
CAVITY 40
FIRST AIR OPENING 41
AT LEAST ONE FAN 410
SECOND AIR OPENING 42
SECOND FAN 420
SEPARATION WALL 444
SHANK 5
HOOF 50
KNEE FLEXION EXTENSION JOINT MECHANISM 51
AT LEAST ONE FIRST CABLE 61
AT LEAST ONE SECOND CABLE 62
AT LEAST ONE THIRD CABLE 63
AT LEAST ONE FOURTH CABLE 64

1. Limb portion, in particular a thigh, for a limb of a robot comprising:
a first actuator adapted to pivotably couple with a first further limb section,
a second actuator adapted to pivotably couple with a second further limb section,
a housing enclosing a first heat source of the first actuator and a second heat source of the second actuator,
wherein the housing forms a cavity,
wherein the housing comprises a first air opening and a second air opening for an airstream to vent the cavity.

2. The limb portion according to claim 1, wherein
the cavity thermally couples to the first heat source and to the second heat source.

3. The limb portion according to claim 1, wherein the housing forms further a second cavity, wherein the housing comprises a third air opening and a fourth air opening for an airstream to vent the second cavity,
in particular, wherein the cavity thermally couples to the second heat source and the second cavity thermally couples to the first heat source.

4. The limb portion according to claim 1, wherein at least one fan is arranged within the cavity to actively vent the cavity.

5. The limb portion according to claim 4, comprising a second fan arranged within the cavity,
wherein the at least one fan is a pull fan for pulling air into the cavity and the second fan is a push fan for pushing air out of the cavity.

6. The limb portion according to claim 4, comprising a second fan arranged within the second cavity, to actively vent the second cavity.

7. The limb portion according to claim 1, wherein a first pivot axis of the first actuator is arranged parallel to a second pivot axis of the second actuator.

8. The limb portion according to claim 1, wherein a first rotation direction of the first pivot axis and a second rotation direction of the second pivot axis are directing in opposite directions.

9. The limb portion according to claim 1, wherein the first actuator is a first electric drive and/or the second actuator is a second electric drive.

10. The limb portion according to claim 9, wherein
the first heat source and/or the second heat source is one or more cooling rib thermally connected to a stator, a circuitry, and/or a gearbox of the respective first and/or second electric drive,

11. The limb portion according to claim 1, further comprising a third actuator wherein the second actuator pivotably couples to the third actuator,
in particular, wherein the second and/or third actuator is adapted to mechanically and electrically couple to a robot torso.

12. The limb portion according to claim 1,
wherein the first actuator pivotaby couples to a shank, in particular by means of a knee flexion extension joint mechanism, and/or
wherein the second actuator pivotably couples to the third actuator by means of a hip flexion extension mechanism.

13. The limb portion according to claim 1, wherein at least one cable, in particular all cables, which connect to the first actuator pass through the cavity.

14. The limb portion according to claim 1,
wherein the first actuator comprises a tubular opening extending along the first pivot axis, in particular adapted to serve as a first cable duct, and/or
wherein the second actuator comprises a tubular opening extending along the second pivot axis, in particular adapted to serve as a second cable duct.

15. The limb portion according to claim 14,
wherein at least one first cable, in particular a power cable, for connecting the first actuator to the robot torso, passes through the cavity and through the second cable duct, and/or
wherein at least one second cable, in particular a power cable, for connecting the second actuator to the robot torso, passes through the second cable duct.

16. The limb portion according to claim 14,
wherein at least one third cable, in particular a logic cable, for connecting the first actuator to the second actuator passes through the cavity, and/or
wherein at least one fourth cable, in particular a logic cable, for connecting the second actuator to the third actuator or to the robot torso, passes through the second cable duct.

17. Limb of a robot, comprising:
a limb portion, in particular a thigh, according to claim 1,
a first further limb section, in particular a shank, coupled to the first actuator with a proximal end of the first further limb section, in particular by means of a knee flexion extension mechanism, and
a second further limb section, in particular a third actuator, coupled to the second actuator, in particular by means of a hip flexion extension mechanism.

18. The limb of a robot according to claim 17,
wherein a hoof is arranged at a distal end of the shank opposite to the proximal end of the shank.

19. Legged robot comprising at least one limb according to claim 17, in particular comprising four limbs.

20. Method for cooling the limb portion according to claim 1, comprising the steps of activating the at least one fan and/or the second fan only if a temperature sensor arranged within the cavity and/or the second cavity measures a specific temperature Tₘₐₓ within the respective cavity and/or second cavity, wherein Tₘₐₓ≥40° C., in particular Tₘₐₓ≥50° C.

21. Method for cooling the limb portion according to claim 1, wherein the at least one fan is arranged close to the first actuator and the second fan is arranged close to the second actuator, comprising the steps of:
activating the at least one fan if a first temperature sensor close to the first actuator measures a temperature Tₘₐₓ≥40° C., and/or
activating the second fan if a second temperature sensor close to the second actuator measures a temperature Tₘₐₓ≥40° C.
